(19) United States
(12) Patent Application Publication
(10) Pub. No.: US 2006/0141195 A1
(43) Pub. Date: Jun. 29, 2006

(54) Ding repair hangtag device

(76) Inventors: Robert Haroutoonian, Huntington Beach, CA (US); Pui Fung Chan, Kowloon (HK)

Correspondence Address: Vic Lin;Myers Dawes Andras & Sherman LLP, Suite 1150, 19900 MacArthur Blvd., Irvine, CA, 92612, US

(21) Appl. No.: 11/248,635

(22) Filed: Oct. 11, 2005

Related U.S. Application Data
(60) Provisional application No. 60/618,903, filed on Oct. 12, 2004.

(51) Int. Cl. B32B 33/00

(52) U.S. Cl. 428/40.1

(57) ABSTRACT

A ding repair hangtag device includes a backing with a first surface and an opposite second surface, and an eyelet for enabling the device to be coupled to an article of merchandise. Several ding repair mechanisms are removably coupled to the first surface of the backing and particularly configured to repair dings on a surfboard. Each ding repair mechanism include a waterproof sticker with indicia on the front surface and a removable wax liner adhered to the rear surface. Once the sticker is detached from the backing and the liner removed from the rear sticker surface, the sticker can be applied to a ding of a surfboard to prevent water from seeping in. Indicia is provided on the first and second surfaces of backing. The device may include transparent sandpaper on the second surface of the backing.

### RELATED APPLICATIONS

This application relates to, claims priority from, and incorporates herein by reference, as if fully set forth, U.S. Provisional Patent Application Ser. No. 60/618,903 filed on Oct. 12, 2004 and entitled “DING REPAIR HANGTAG”.

### BACKGROUND OF THE INVENTION

1. Field of the Invention

The invention relates generally to hangtags and product labels.

2. Description of Prior Art and Related Information

Certain merchandise, typically surf clothing or “surfwear”, is targeted towards consumers who surf. Such surfwear may comprise board shorts, T-shirts, pants, jackets, short sleeve button-up shirts, knit shirts, and more. Conventional hangtags affixed to such merchandise typically bear the manufacturer's trademarks. At times, such conventional hangtags may provide certain information, such as instructions for use or care. Thus, hangtags in the prior art are limited in their utility since they typically do nothing more than provide some text or graphics concerning the product and its manufacturer. Once the product is purchased, conventional hangtags are commonly cut off from the product and discarded.

### SUMMARY OF THE INVENTION

In accordance with the present invention, structures and associated methods are disclosed which address these needs and overcome the deficiencies of the prior art.

In one aspect, a ding repair hangtag device is configured to be coupled to an article of merchandise. The device comprises a backing having a first surface and an opposite second surface and an opening defined in the backing for receiving a connector. A ding repair mechanism is removably affixed to the first surface of the backing. The device may further comprise a plurality of ding repair mechanisms removably coupled to the first surface of the backing. The multiple ding repair mechanisms are preferably stacked on top of each other and configured to be easily detached from the backing.

The ding repair mechanism preferably comprises a waterproof sticker adapted to be affixed to a surface of a surfboard. The waterproof sticker comprises a glossy, non-adhesive front sticker surface and an adhesive rear sticker surface. The device further comprises a liner removably affixed to the adhesive rear sticker surface. The waterproof sticker comprises indicia on the non-adhesive front sticker surface. The device may further comprise a second waterproof sticker removably coupled to the backing.

Sandpaper may be affixed to the second, rear surface of the backing. In a preferred embodiment, the sandpaper is substantially transparent. The second surface may also comprise indicia that is visible through the transparent sandpaper.

Indicia may be provided in the first and second surface of the backing.

In another aspect, a ding repair hangtag device comprises a backing with a first backing surface and an opposite second backing surface, and a substantially planar ding repair mechanism detachably coupled to the first surface. The ding repair mechanism comprises a front surface and an adhesive rear surface. The device further comprises a liner removably affixed to the adhesive rear surface of the ding repair mechanism. The front surface of the ding repair mechanism comprises indicia. The first backing surface and the second backing surface may comprise indicia. The device further comprises sandpaper coupled to the second backing surface.

In a further aspect, a ding repair device is provided. The ding repair devices comprising an article of clothing, preferably new, and a hangtag coupled to the article of clothing. The hangtag includes a backing with a first backing surface and an opposite second backing surface, and a substantially planar ding repair mechanism detachably coupled to the first surface. The ding repair mechanism comprises a front surface and an adhesive rear surface. Indicia may be provide on the first backing surface and the second backing surface. Indicia may also be provided on the front surface of the ding repair mechanism. A liner is removably adhered to the adhesive rear surface of the ding repair mechanism.

In summary, a ding repair hangtag device includes a backing with a first surface and an opposite second surface, and an eyelet for enabling the device to be coupled to an article of merchandise. Several ding repair mechanisms are removably coupled to the first surface of the backing and particularly configured to repair dings on a surfboard. Each ding repair mechanism include a waterproof sticker with indicia on the front surface and a removable wax liner adhered to the rear surface. Once the sticker is detached from the backing and the liner removed from the rear sticker surface, the sticker can be applied to a ding of a surfboard to prevent water from seeping in. Indicia is provided on the first and second surfaces of backing. The device may include transparent sandpaper on the second surface of the backing.

The invention, now having been briefly summarized, may be better visualized by turning to the following drawings wherein like elements are referenced by like numerals.

### BRIEF DESCRIPTION OF THE DRAWINGS

FIG. 1 is a front elevation view of a first preferred embodiment of a ding repair hangtag device according to the invention:

FIG. 2 is a perspective view of the preferred ding repair hangtag device;

FIG. 3 is a perspective of the preferred ding repair hangtag device illustrating a ding repair mechanism being removed therefrom;

FIG. 4 is a rear elevation view of the first preferred embodiment of the ding repair hangtag device;

FIG. 5 is an operative view of the preferred ding repair mechanism being applied to cover a ding on an object, such as a surfboard; and

FIG. 6 is a rear elevation view of a second preferred embodiment of the ding repair hangtag device.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

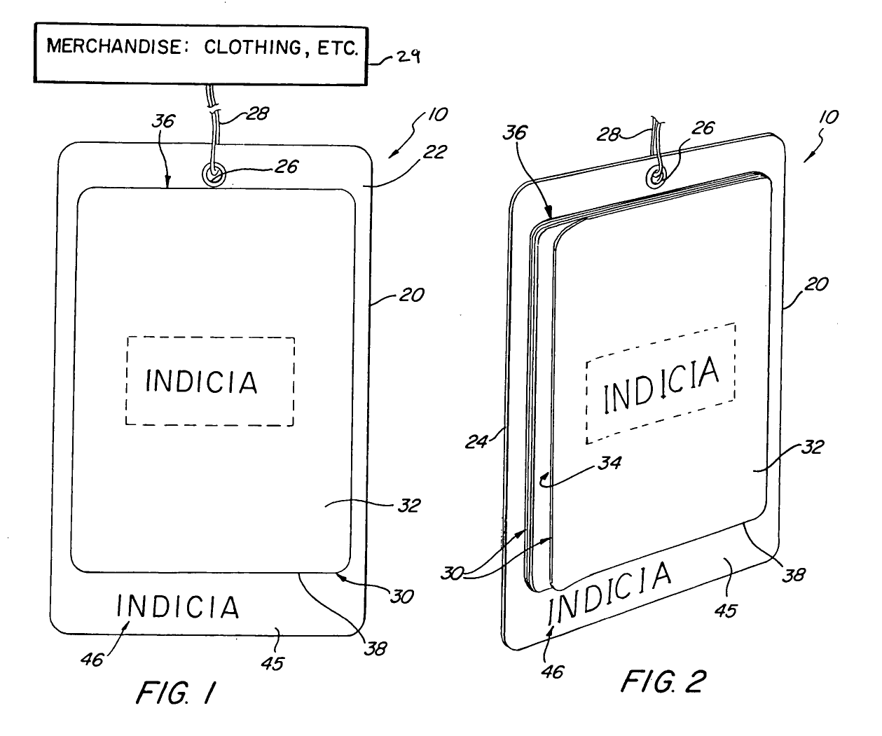

A first preferred embodiment of a ding repair hangtag device is illustrated in FIGS. 1 and 2 and designated generally by the reference numeral 10. The device 10 preferably comprises a substantially thin and planar backing 20 with a first, or front, surface 22 and a second opposite, or rear, surface 24. A through hole, or eyelet, 26 is defined through the backing 20 and adapted to receive a fastener or any other commonly known connector mechanism 28 to enable the hangtag device 10 to be coupled to a piece of merchandise 29, such as an article of clothing. Annular reinforcements may be provided to strengthen the eyelet 26. In the preferred embodiment, the hangtag device 10 is particularly useful as a hangtag on surf clothing or surf related accessories, such as T-shirts, board shorts, swimsuits, wetsuits, and the like.

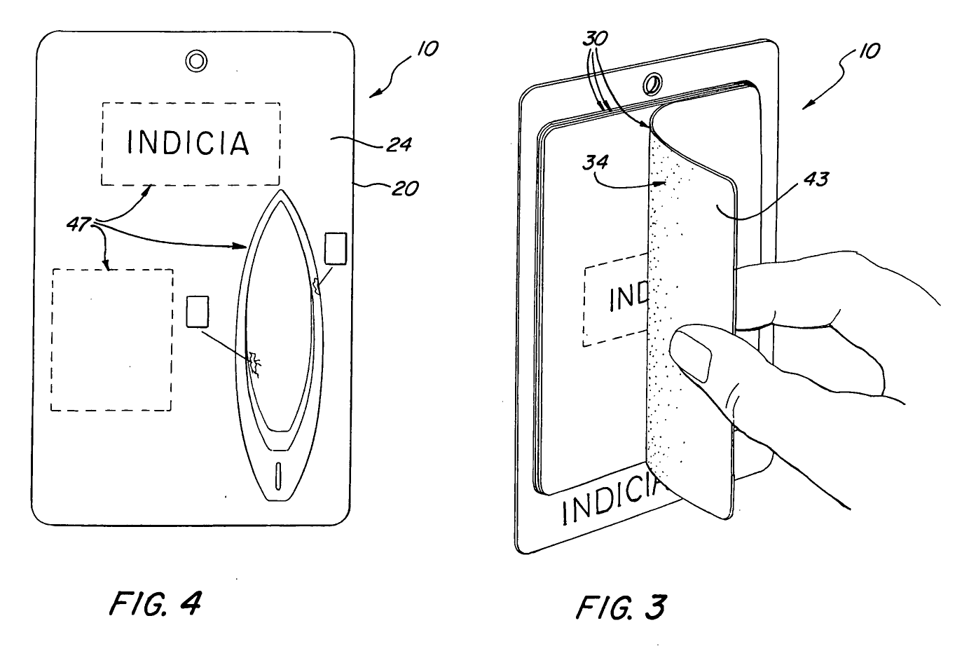

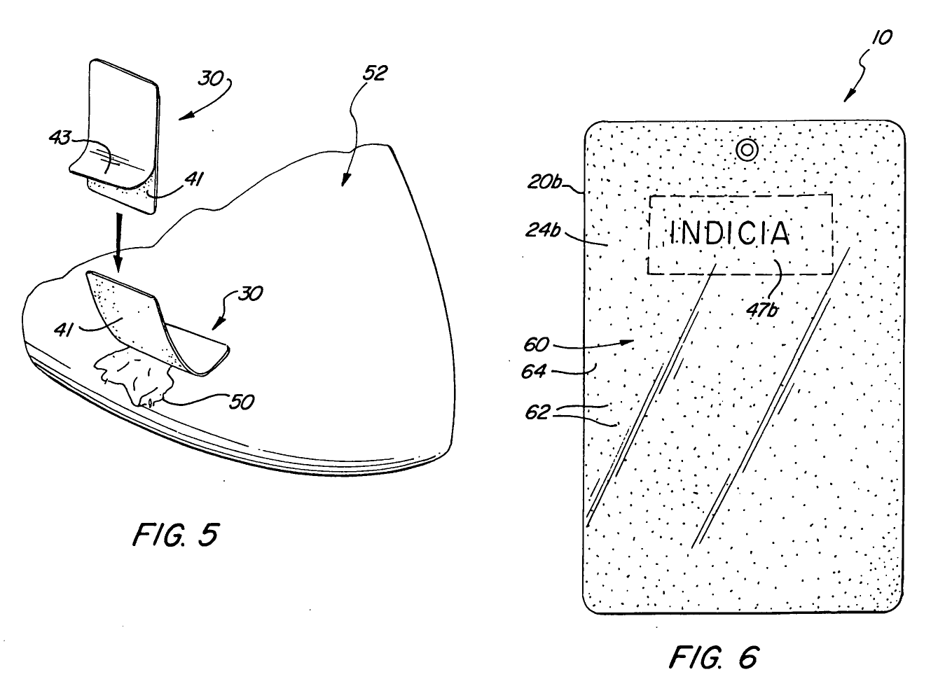

The device 10 comprises at least one ding repair mechanism 30 removably, or detachably, coupled to the first backing surface 22. In one preferred embodiment, the ding repair mechanism 30 is configured to repair dings on a surfboard and comprises a sticker 30 detachably coupled to the backing 20. Each sticker 30 includes a front sticker surface 32, a rear sticker surface 34, a top 36 and a bottom 38 as best shown in FIGS. 2 and 3. The sticker 30 is preferably flexible and composed of a plastic tape material. As shown in FIG. 5, an adhesive 41 is disposed on the rear sticker surface 34. In FIG. 3, a removable wax liner 43 is adhered to the rear sticker surface 34 to prevent the adhesive surface 34 from adhering to the backing 20 or to an adjacent sticker 30. In the preferred embodiment, the device 10 comprises a plurality of stacked stickers 30 removably coupled to the backing 20 to enable the consumer or user to repair multiple dings with a single device 10. The stickers 30 are preferably disposed, or stacked, on top of one another and removably adhered to each other or the backing 20 at the top end 36. An adhesive material may be disposed on the tops 36 of the ding repair mechanisms 30 to removably couple the mechanisms 30 to each other and the backing 20.

Since hangtags often serve as a marketing tool, it will be appreciated that the preferred ding repair mechanism 30 not only serves a useful function, but also provides substantial surface area on the front sticker surface 32 for bearing a name, logo, graphic and/or any other marketing indicia. Accordingly, the front sticker surfaces 32 are preferably non-adhesive and formed with an attractive glossy finish. In the preferred embodiment as shown in FIG. 1, the surface area of the ding repair mechanism 30 is less than the surface area of the backing 20 in order to expose portions 45 of the front backing surface 22. The exposed portions 45 of the front backing surface 22 thus provide further room for additional indicia 46. As used herein, “indicia” shall include any words, graphics and any other printed matter. Thus, indicia comprises, but is not limited to, names, instructions, logos, trademarks, pictures, photographs, images, artwork and any combination thereof. For purposes of marketing and providing indication of source, the front sticker surface 32 and the front backing surface 22 may bear trademarks for the merchandise to which the hangtag device 10 is attached

FIG. 4 is a rear elevation view of the first preferred embodiment of the hangtag device 10. The rear surface 24 of the backing 20 may also bear indicia 47. In the first preferred embodiment, the rear backing surface 24 includes printed information and instructions 47 to show the consumer how to use the ding repair mechanism 30 (shown in FIGS. 1-3). Thus, where the ding repair mechanism 30 shown in FIGS. 1-3 is particularly configured to repair dings on a surfboard, the instructions 47 may include both written text and pictures to show application of the ding repair mechanism 30.

FIG. 5 is a perspective, operative view of the preferred ding repair mechanism 30 being applied to repair a ding 50 on an object 52, such as a surfboard. In the preferred embodiment, the ding repair mechanism 30 is particularly configured to repair dings 50 on a surfboard 52. Accordingly, the ding repair mechanism 30 preferably comprises a waterproof sticker 30 with a strong waterproof adhesive 41 on the rear sticker surface 34. In operation, the wax liner 43 is removed from the sticker 30 to expose the rear adhesive surface 34. The sticker 30 is then applied over the ding 50 with the rear adhesive surface 34 attaching to the surface of the board 52. When applied to a surfboard 52, the sticker 30 prevents water from seeping into the surfboard 52, thereby resisting water logging and extending the life of the board. The waterproof adhesive 41 prevents the sticker 30 from disengaging the board 52 when submerged in water. Since the preferred embodiment of the hangtag device 10 includes multiple ding repair mechanisms 30, it will be appreciated that a single device 10 attached to a new article of merchandise provides the purchaser with the opportunity of repairing multiple dings.

It is to be expressly understood that the hangtag device 10 according to the invention may include a ding repair mechanism that is particularly related to the item of merchandise to which the hangtag device 10 is coupled. Thus, where the hangtag device 10 is adapted to be coupled to a paint brush, for example, the ding repair mechanism 30 may comprise a tape to be applied to a wall or other surface to be painted. Thus, the hangtag device 10 is particularly useful to repair or cover any object susceptible to dings, dents, cracks or any other such imperfections. The device 10 may be particularly targeted at consumers who are likely to own objects with imperfections which may be repaired or concealed with a planar tape or sticker. Accordingly, the hangtag device 10 may be employed as a marketing tool by incorporating a ding repair mechanism 30 that is specially targeted toward, or related to, the product to which the device 10 is attached.

FIG. 6 is a rear elevation view of a second preferred embodiment of the hangtag device 10 where elements of similar structure are designated by the same reference numerals followed by the lower case “b”. The hangtag device 10 comprises sandpaper 60 coupled to the rear surface 24b of the backing 20b. The sandpaper 60 is preferably transparent and, thus, comprises granules 62 attached to a transparent sheet 64. By making the sandpaper 60 transparent, the indicia 47b on the rear backing surface 24 is visible through the sandpaper 60. Where the hangtag device 10b is adapted to be attached to merchandise related to surfing, such as clothing, surfboards, or other surfing accessories, it will be appreciated that the device 10b provides a complete surfboard ding repair kit. In particular, the sandpaper 60 enables a user to sand away existing wax on a surfboard to expose the ding and provide direct contact to the surface surrounding the ding. The user can then apply the ding repair mechanism 30 on the ding and wax over the covered up area. The sandpaper 60 may also be useful for sanding surfaces of any other object prior to application of the ding repair mechanism.

Since surfers often adorn their surfboards with stickers to express their own personal style, it will be appreciated that the device 10 according to the invention enables surfers to provide such expressions, and thereby conceal dings without drawing attention to them. Alternatively, the ding repair mechanisms 30 according to the invention need not bear any indicia. Instead, the stickers 30, or at least the front surfaces 32 thereof, may simply be colored white or ivory in conformity with the general colors of surfboards, thereby enabling the user to simply repair a ding and conceal the repair.

It will be appreciated that a ding repair device is also provided according to the invention. In particular, the above embodiments of the hangtag device 10 may be coupled to an article of merchandise, such as clothing, to collectively form a ding repair device. In other words, the ding repair device comprises an article of merchandise, generally new, coupled to the ding repair hangtag device 10 described above.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A ding repair hangtag device configured to be coupled to an article, the device comprising:
a backing having a first surface and an opposite second surface;
an opening defined in the backing for receiving a connector; and
a ding repair mechanism removably affixed to the first surface of the backing.

2. The device of claim 1, wherein the ding repair mechanism comprises a waterproof sticker adapted to be affixed to a surface of an object having a ding.

3. The device of claim 2, wherein the waterproof sticker comprises a non-adhesive front sticker surface and an adhesive rear sticker surface, the device further comprising a liner removably affixed to the adhesive rear sticker surface.

4. The device of claim 3, wherein the waterproof sticker comprises indicia on the non-adhesive front sticker surface.

5. The device of claim 3, wherein the waterproof sticker comprises a first waterproof sticker, the device further comprising a second waterproof sticker removably coupled to the backing.

6. The device of claim 1, further comprising sandpaper affixed to the second surface of the backing.

7. The device of claim 6, wherein:
the sandpaper is substantially transparent;
the second surface comprises indicia.

8. The device of claim 1, further comprising indicia on the second surface of the backing.

9. A ding repair hangtag device, comprising:
a backing with a first backing surface and an opposite second backing surface; and
a substantially planar ding repair mechanism detachably coupled to the first surface, the ding repair mechanism comprising a front surface and an adhesive rear surface.

10. The device of claim 9, further comprising a liner removably affixed to the adhesive rear surface of the ding repair mechanism.

11. The device of claim 9, wherein the front surface of the ding repair mechanism comprises indicia.

12. The device of claim 9, wherein the second backing surface comprises indicia.

13. The device of claim 9, further comprising sandpaper coupled to the second backing surface.

14. The device of claim 9, wherein the front surface of the ding repair mechanism is non-adhesive and glossy.

15. A ding repair device, comprising:
an article of clothing; and
a hangtag coupled to the article of clothing, the hangtag including:
a backing with a first backing surface and an opposite second backing surface; and
a substantially planar ding repair mechanism detachably coupled to the first surface, the ding repair mechanism comprising a front surface and an adhesive rear surface.

16. The device of claim 15, further comprising indicia on the second backing surface.

17. The device of claim 15, further comprising indicia on the front surface of the ding repair mechanism.

18. The device of claim 15, further comprising a liner removably adhered to the adhesive rear surface of the ding repair mechanism.
